(19) United States
(12) Patent Application Publication
(10) Pub. No.: US 2007/0065780 A1
(43) Pub. Date: Mar. 22, 2007

(54) Composite paste for dental prostheses

(75) Inventors: Gregory J. Dorsman, Costa Mesa, CA (US); Raymond L. Bertolotti, Oakland, CA (US)

Correspondence Address: FOLEY & LARDNER LLP, 1530 PAGE MILL ROAD, PALO ALTO, CA, 94304, US

(73) Assignee: Danville Materials, Inc.

(21) Appl. No.: 11/520,450

(22) Filed: Sep. 12, 2006

Related U.S. Application Data
(60) Provisional application No. 60/717,215, filed on Sep. 14, 2005.

(51) Int. Cl. A61C 5/00

(52) U.S. Cl. 433/215

(57) ABSTRACT

In general, the invention comprises a composite paste (“try-in paste”) made with the same or similar components in similar proportions as a veneer cement except part or all of the initiation system is removed or reduced to cause it to have an extended working time under the type of ambient light conditions expected during the trial placement of the veneer. Preferably, the imitator is decreased by not eliminated from the try-in paste. The invention can be presented in the form of a kit containing one or more shades of veneer cement with corresponding shades of try-in paste.

### I. CROSS-REFERENCE TO RELATED APPLICATIONS

This application claims benefit of the provisional U.S. Application Ser. No. 60/717,215, filed 14 Sep. 2005, incorporated herein by reference in its entirety.

### II. BACKGROUND OF THE INVENTION

One of the goals for successful tooth restoration using a dental prosthesis in the form of a veneer, inlay, or on-lay of porcelain, ceramic, or composite is to provide a certain resultant shade, either to match adjoining dentition or to improve or lighten the natural shade. The final shade of a veneer-restored tooth is dependent on the shades and transparencies of the component layers: the tooth, veneer cement, and veneer. The dentist provides information to a fabrication laboratory to obtain a veneer with the desired shape and shade. The dentist must then decide which veneer cement shade to use to affix the veneer to the tooth. In many cases, translucent neutrally shaded cement gives an adequate result. Various shades of veneer cement are available that can lighten the result further or shift the shade to better match other dentition. Trial placements are used to determine which cement is likely to provide the best result.

At the patient seating appointment, it is desirable to place the veneer on the tooth in a trial fashion so as to see the effect of the veneer cement on the shade outcome. The veneer cements can be used for this trial purpose, but since they are generally reactive to visible light, there is a very limited time to review the result in ambient lighting conditions before the cement begins to polymerize. After that point it may be hard to remove the veneer without damaging it, so that a second trial with a different shade could be impossible. To overcome this problem, many commercial veneer cement systems are provided with like-shaded gels (“try-in gels”) that are used as substitute for the cement for this purpose. Typically, the currently available try-in gels are water-soluble to permit the gel to be washed from the tooth and veneer using only water rather than solvents. Removal of the try-in gel permits the dentist to replace the gel with another shade of try-in gel, if the original gel does not provide the correct color, or to apply the veneer cement. Many of the presently marketed try-in products contain glycerin and water with gelatin and/or fumed silica added to provide body. These products include Calibra Esthet-X (Dentsply/LD Caulk), Nexus and Nexus II (Kerr Mfg.), Variolink II (Ivoclar), Insure Prevue (Cosmedent), da vinci (Cosmedent), Lute-It (Pentron), and Illusion (Bisco). U.S. Pat. No. 6,579,919 to Mark Konings describes a try-in kit based on polyethylene glycols (PEG) without water, but these gels are still washed off with a stream of water. A commercial example of try-ins based on PEG is Rely-X (3M/ESPE). Another example of try-ins is Ultra-Bond try-in paste (Den-Mat) that has all the chemical components of a bonding cement minus the photo or chemical bond initiators, reported by Shuman (Dent Today, 2004, 23(3):66-68, 70, 72 passim).

While providing somewhat satisfactory results, a major disadvantage of the prior art is that quite often the shade previewed using the try-in gel is not the same as the shade obtained when the veneer is cemented in, even though the like-shaded cement is used. Further, the try-in gel can have an adverse effect on adhesion, especially at the veneer surface, if it and the water used to remove it are not carefully and fully removed. Accordingly, it would be desirable to provide a veneer try-in system that allows a more accurate preview of the final result while giving the dentist adequate time to do so and a simple way of replacing the trial material with the chosen veneer cement without negatively affecting the bond strength.

### III. SUMMARY OF THE INVENTION

In general, the invention comprises a composite paste (“try-in paste”) made with the same or similar components in similar proportions as a veneer cement except part or all of the initiation system is removed or reduced to cause it to have an extended working time under the type of ambient light conditions expected during the trial placement of the veneer. Preferably the amount of imitator is decreased, but not eliminated from the composition. The invention can be presented in the form of a kit containing one or more shades of veneer cement with corresponding shades of try-in paste. Veneer cements that can be matched with try-in pastes of the invention are typically supplied in one part that does not require mixing just prior to use.

One aspect of the present invention provides dental try-in pastes that comprise a dentally-acceptable particulate material, a dentally-acceptable organic material that polymerizes to aid in bonding a tooth prosthesis to a patient's tooth, a polymerization initiator for the organic material and optionally a polymerization accelerator, wherein the try-in paste is not water-removable and wherein the initiator and the accelerator are present in an amount to give the try-in paste extended working time during a trial placement of the tooth prosthesis to the patient's tooth so that the shading of the prosthesis is appropriately matched to the patient's other teeth. Preferably the particulate material is present in an amount of about 30% w/w to about 80% w/w and the organic material is present in an amount of about 20% w/w to about 70% w/w. In some embodiments of the invention, the particulate material has a maximum particle diameter of less than 50 micrometers. The particulate material preferably is a combination of a filler and a pigment. In certain embodiments of the invention, the polymerization accelerator is absent. The polymerizable organic material may be a methacrylate compound, preferably a Bowen monomer, bis-GMA, an alkyl dimethacrylate, ethoxylated Bis-GMA, a diurethane dimethacrylate, or mixtures thereof. Those familiar with the art may substitute acrylates or alkyl acrylates for methacrylates, as desired.

Another aspect of the invention provides methods for selecting a veneer cement for bonding a dental prosthesis to a tooth of a patient, which method comprises selecting a first try-in paste for trial placement of the prosthesis on the tooth; applying the dental prosthesis to the tooth of the patient using the try-in paste; comparing the shading of the dental prosthesis having the try-in paste applied thereto to the shading of the other teeth of the patient to determine if there is an appropriate match removing all or some of the try-in paste from the tooth and prosthesis surfaces; and bonding the prosthesis to the tooth using a corresponding veneer cement; wherein the try-in paste comprises essentially the same composition as the veneer cement but has a reduced amount of polymerization initiator and/or polymerization accelerator to give the try-in paste extended working time during the trial placement of the tooth.

Yet another aspect of the invention provides kits for selecting a veneer cement for bonding a dental prosthesis to a tooth of a patient, which kit comprises a try-in paste for trial placement of the prosthesis on the tooth and a dental paste, for permanently adhering the prosthesis to the tooth, wherein the try-in paste comprises essentially the same composition as the veneer cement but has a reduced amount of polymerization initiator and/or polymerization accelerator to give the try-in paste extended working time during the trial placement of the prosthesis.

### IV. DETAILED DESCRIPTION OF THE PREFERRED EMBODIMENTS

The try-in gels of the prior art fail because they do not match the refractive index (n_{D}) of the set veneer cement they are trying to mimic. U.S. Pat. No. 4,715,813 to Ernst Mühlbauer teaches that tooth color is complex. To recreate tooth color in a lifelike manner, one must take into account that the restored tooth is made up of various layers. The shade of a restoration built in layers depends on the color, transparency, and refractive index of each layer. While commercial try-in gels may match their corresponding cement shades when on a white background under incandescent light, frequently there is a shade mismatch when placed on a tooth-colored background or viewed under other light sources such as D65 or sunlight. The tooth and veneer layers remain the same during trial and final veneer placement, but the refractive indices of the try-in gel and cement do not match well. The present invention takes advantage of the easiest way to get a refractive index match between two formulations, i.e. to use substantially the same ingredients in each. Such an approach also increases the likelihood of a shade and transparency match as well.

A. Try-in Pastes

One aspect of the present invention provides try-in dental pastes that comprise a dentally-acceptable particulate material, a dentally-acceptable organic material that polymerizes to aid in bonding a tooth prosthesis to a patient's tooth, a polymerization initiator for the organic material and optionally a polymerization accelerator, wherein the try-in paste is not water-removable and wherein the initiator and the accelerator are present in an amount to give the try-in paste extended working time during a trial placement of the tooth prosthesis to the patient's tooth so that the shading of the tooth with definitive prosthesis is appropriately matched to the patient's other teeth. The term “water-removable” refers to a composition that can be washed off a dental prosthesis or tooth with running water. A composition that is not water-removable typically is not water-soluble or has only limited, or very low, solubility in water.

For veneer cements (also known as luting cements), as well as most resin-based dental restoratives, the ingredients that affect the refractive index, shade, and transparency are the polymerizable organic material, particulate material (such as fillers and pigments) and initiation system, including initiators and optional accelerators. The cements may contain other constituents to improve shelf stability or to provide desired rheological properties. These additives are well known to those practiced in the art, but generally do not significantly contribute to the color or transparency.

While it is easiest to use the cement ingredients listed above to formulate a try-in paste to provide a good match, any of the components can be substituted with similar quantities of similar materials of similar refractive index and color, in order to, e.g., reduce the cost or shorten processing time. Also, slight adjustments of the component amounts used in the try-in paste may also help it to match the cured veneer cement even better. It is typical that when a resin-based restorative polymerizes, its refractive index increases. Therefore, the best match is obtained when the try-in paste formulation has the same average refractive index as the cured veneer cement. Ideally, the refractive index difference is not more than 0.05 units. More preferably, the refractive index difference is less than 0.01 units. Most preferably, the refractive index difference is less than 0.005 units. Another observation is that when cements containing colored initiators are photocured, the color contributed by the initiator is reduced. Therefore, it is advantageous to reduce the amount of initiator present in the try-in paste to less than the full amount present in the corresponding veneer cement. Generally, a single try-in paste has one corresponding veneer cement. As used herein, a “corresponding” try-in paste is one that is appropriately matched to the veneer cement with respect to its final polymerized shade (typically, color, and preferably color and opacity).

Although it is advantageous to decrease the content of initiator in the try-in paste compared to the veneer cement for the best color match, both the initiator and the accelerator can be reduced or eliminated. Similarly, it is possible to utilize a composition in which the amount of initiator remains the same as that of the veneer cement and only the amount of accelerator is reduced or eliminated. When at least a portion of the initiator remains, the quantity of accelerator used directly affects the working or viewing time. Reducing the amount of accelerator extends the viewing time. Therefore, it is most advantageous to greatly reduce or remove the accelerator while only partially reducing the amount of initiator.

1. Polymerizable Organic Material

The dental try-in pastes of the present invention comprise a dentally-acceptable organic material that polymerizes. Any known polymerizable organic material that has been used as a dental composite material can be utilized in the present invention without any limitation. The polymerizable organic material may be present in the try-in paste in an amount that is between about 20% w/w and about 70% w/w of the paste. More preferably, the polymerizable organic material is present in an amount of about 30% w/w to about 60% w/w.

Monomers typically are methacrylate compounds such as a Bowen monomer (reviewed in N. Moszner, U. Salz, “New developments of polymeric dental composites,” Prog. Polym. Sci 26 (2001) 535-576), Bis-GMA, and related backbone and diluent species, but are not necessarily limited to this chemical class. The polymerizable organic material can be made of any species that can be made to harden either by mixing two component parts or by activating with external radiation such as visible or ultraviolet light.

One preferred embodiment of the invention comprises methacrylates that comprise monofunctional vinyl monomers. This group includes methacrylates such as methyl methacrylate, ethyl methacrylate, isopropyl methacrylate, hydroxyethyl methacrylate, tetrahydrofurfuryl methacrylate, glycidyl methacrylate, and acrylates corresponding to these methacrylates; and acrylic acid, methacrylic acid, p-methacryloyloxybenzoic acid, N-2-hydroxy-3-methacryloyloxypropyl-N-phenylglycine, 4-methacryloyloxyethyltrimellitic acid, and anhydrides thereof, 6-methacryloyloxyhexamethylenemalonic acid, 10-methacryloyloxydecamethylenemalonic acid, 2-methacryloyloxyethyldihydrogen phosphate, and 10-methacryloyloxydecamethylenedihydrogen phosphate.

Another preferred embodiment of the present invention comprises methacrylates that comprise bifunctional vinyl monomers. Accordingly, the try-in paste may comprise methacrylates comprising aromatic compounds, such as 2,2-Bis(methacryloyloxyphenyl)propane, 2,2-bis[4-(3-methacryloyloxy)-2-hydroxypropoxyphenyl]propane (hereinafter abbreviated as bis-GMA), 2,2-bis(4-methacryloyloxyphenyl)propane, 2,2-bis(4-methacryloyloxypolyethoxyphenyl)propane (hereinafter abbreviated as D-2.6E), 2,2-bis(4-methacryloyloxydiethoxyphenyl)propane, 2,2-bis(4-methacryloyloxytetraethoxyphenyl)propane, 2,2-bis(4-methacryloyloxypentaethoxyphenyl)propane, 2,2-bis(4-methacryloyloxydipropoxyphenyl)propane, 2-(4-methacryloyloxyethoxyphenyl)-2-(4-methacryloyloxydiethoxyphenyl)propane, 2-(4-methacryloyloxydiethoxyphenyl)-2-(4-methacryloyloxyditriethoxyphenyl)propane, 2-(4-methacryloyloxydipropoxyphenyl)-2-(4-methacryloyloxytriethoxyphenyl)propane, 2,2-bis(4-methacryloyloxypropoxyphenyl)propane, 2,2-bis(4-methacryloyloxyisopropoxyphenyl)propane, and acrylates corresponding to these methacrylates. The methacrylates may also be a di-adduct obtained by the addition reaction of a vinyl monomer having an —OH group like such methacrylate as 2-hydroxyethyl methacrylate, 2-hydroxypropyl methacrylate or 3-chloro-2-hydroxypropyl methacrylate, or an acrylate corresponding to these methacrylates and a diisocyanate compound having an aromatic group, such as diisocyanatemethyl benzene or 4,4′-diphenylmethane diisocyanate. The bifunctional vinyl monomer may also comprise an aliphatic compound. Exemplary aliphatic bifunctional vinyl monomers include, but are not limited to, ethylene glycol dimethacrylate, diethylene glycol dimethacrylate, triethylene glycol dimethacrylate (hereinafter abbreviated as 3G), butylene glycol dimethacrylate, neopentyl glycol dimethacrylate, propylene glycol dimethacrylate, 1,3-butanediol dimethacrylate, 1,4-butanediol dimethacrylate, 1,6-hexanediol dimethacrylate, and acrylates corresponding to these methacrylates; di-adducts obtained by the addition reaction of a vinyl monomer having an —OH group like such methacrylate as 2-hydroxyethyl methacrylate, 2-hydroxypropyl methacrylate, 3-chloro-2-hydroxypropyl methacrylate or acrylate corresponding to the methacrylate and a diisocyanate compound such as hexamethylene diisocyanate, trimethylhexamethylene diisocyanate, diisocyanatemethylcyclohexane, isophorone diisocyanate, or methylenebis(4-cyclohexyl isocyanate); and acrylic anhydride, methacrylic anhydride, 1,2-bis(3-methacryloyloxy-2-hydroxypropoxy)ethyl, and di(2-methacryloyloxypropyl)phosphate.

Another preferred embodiment of the invention utilizes trifunctional vinyl monomers of methacrylates, such as trimethylolpropane trimethacrylate, trimethylolethane trimethacrylate, pentaerythritol trimethacrylate and trimethylolmethane trimethacrylate, and acrylates corresponding to these methacrylates. Try-in pastes of the present invention may also comprise tetrafunctional vinyl monomers, such as pentaerythritol tetramethacrylate and pentaerythritol tetraacrylate; and adducts obtained by the addition reaction of a diisocyanate compound such as diisocyanatemethylbenzene, diisocyanatemethylcyclohexane, isophoronediisocyanate, hexamethylenediisocyanate, trimethylhexamethylenediisocyanate, methylenebis(4-cyclohexylisocyanate), 4,4-diphenylmethanediisocyanate or tolylene-2,4-diisocyanate with a glycidol dimethacrylate.

Preferably the polymerizable organic material comprises a Bowen monomer, bis-GMA, triethylene glycol dimethacrylate, ethoxylated Bis-GMA, triethyleneglycol dimethacrylate or mixtures thereof.

Other preferred polymerizable components can be substituted acryl amides and methacrylamides. Examples are acrylamide, methylene bis-acrylamide, methylene bis-methacrylamide, diacetone/acrylamide diacetone methacylamide, N-alkyl acrylamides and N-alkyl methacrylamides where alkyl is a lower hydrocarbyl unit. Other suitable examples of polymerizable components are isopropenyl oxazoline, vinyl azalactone, vinyl pyrrolidone, styrene, divinylbenzene, urethane acrylates or methacrylates, epoxy acrylates or methacrylates and polyol acrylates or methacrylates.

Alternatively, the polymerizable component may be a cationically cured material, such as epoxy materials, oxetanes, oxolanes, cyclic acetals, lactams, lactones, and vinyl ethers or spirocyclic compounds containing O atoms in the rings.

The cationically polymerizable epoxy resins useful in the compositions of the invention comprise organic compounds having an oxirane ring, i.e., 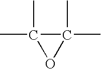
polymerizable by ring opening. Such materials, broadly called epoxides, include monomeric epoxy compounds and epoxides of the polymeric type and can be aliphatic, cycloaliphatic, aromatic or heterocyclic. These materials generally have, on the average, at least 1 polymerizable epoxy group per molecule, and preferably at least about 1.5 polymerizable epoxy groups per molecule. The polymeric epoxides include linear polymers having terminal epoxy groups (e.g., a diglycidyl ether of a polyoxyalkylene glycol), polymers having skeletal oxirane units (e.g., polybutadiene polyepoxide), and polymers having pendent epoxy groups (e.g., a glycidyl methacrylate polymer or copolymer). The epoxides may be pure compounds or may be mixtures containing one, two, or more epoxy groups per molecule. The “average” number of epoxy groups per molecule is determined by dividing the total number of epoxy groups in epoxy-containing material by the total number of epoxy molecules present.

These epoxy-containing materials may vary from low molecular weight monomeric materials to high molecular weight polymers and may vary greatly in the nature of their backbone and substituent groups. For example, the backbone may be of any type and substituent groups thereon can be any group that does not substantially interfere with cationic cure at room temperature. Illustrative of permissible substituent groups include halogens, ester groups, ethers, sulfonate groups, siloxane groups, nitro groups, phosphate groups, and the like. The molecular weight of the epoxy-containing materials may vary from about 58 to about 100,000 or more.

Useful epoxy-containing materials include those which contain cyclohexene oxide groups such as the epoxycyclohexanecarboxylates, typified by 3,4-epoxycyclohexylmethyl-3,4-epoxycyclohexanecarboxylate, 3,4-epoxy-2-methylcyclohexylmethyl-3,4-epoxy-2-methylcyclohexane carboxylate, and bis(3,4-epoxy-6-methylcyclohexylmethyl) adipate. For a more detailed list of useful epoxides of this nature, reference is made to the U.S. Pat. No. 3,117,099, incorporated herein by reference.

Further epoxy-containing materials which are particularly useful in the practice of this invention include glycidyl ether monomers of the formula

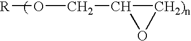

where R is alkyl or aryl and n is an integer of 1 to 6. Examples are glycidyl ethers of polyhydric phenols obtained by reacting a polyhydric phenol with an excess of chlorohydrin such as epichlorohydrin (e.g., the diglycidyl ether of 2,2-bis-(2,3-epoxypropoxyphenol)-propane). Further examples of epoxides of this type that can be used in the practice of this invention are described in U.S. Pat. No. 3,018,262, incorporated herein by reference, and in “Handbook of Epoxy Resins” by Lee and Neville, McGraw-Hill Book Co., New York (1967).

There are a host of commercially available epoxy resins which can be used in this invention. In particular, epoxides which are readily available include octadecylene oxide, epichlorohydrin, styrene oxide, vinyl cyclohexene oxide, glycidol, glycidylmethacrylate, diglycidyl ether of Bisphenol A, vinylcyclohexene dioxide, 3,4-epoxycyclohexylmethyl-3,4-epoxycyclohexene carboxylate, 3,4-epoxy-6-methylcyclohexylmethyl-3,4-epoxy-6-methyl-cyclohexene carboxylate, bis(3,4-epoxy-6-methylcyclohexylmethyl)adipate, bis(2,3-epoxycyclopentyl)ether, aliphatic epoxy modified with polypropylene glycol, dipentene dioxide, epoxidized polybutadiene, silicone resin containing epoxy functionality, flame retardant epoxy resins, 1,4-butanediol diglycidyl ether of phenolformaldehyde novolak, and resorcinol diglycidyl ether, bis(3,4-epoxycyclohexyl)adipate, 2-(3,4-epoxycyclohexyl-5,5-spiro-3,4-epoxy)cyclohexane-meta-dioxane, vinylcyclohexene monoxide, 1,2-epoxyhexadecane, alkyl glycidyl ethers such as alkyl C₈-C₁₀ glycidyl ether, alkyl C₁₂-C₁₄ glycidyl ether, butyl glycidyl ether, cresyl glycidyl ether, p-tert butylphenyl glycidyl ether, polyfunctional glycidyl ethers such as diglycidyl ether of 1,4-butanediol, diglycidyl ether of neopentyl glycol, diglycidyl ether of cyclohexanedimethanol, trimethylol ethane triglycidyl ether, trimethylol propane triglycidyl ether, polyglycidyl ether of an aliphatic polyol, polyglycol diepoxide, bisphenol F epoxides, 9,9-bis[4-(2,3-epoxypropoxy)-phenyl]fluorenone.

Still other epoxy resins contain copolymers of acrylic acid esters or glycidol such as glycidylacrylate and glycidylmethacrylate with one or more copolymerizable vinyl compounds. Examples of such copolymers are 1:1 styrene-glycidylmethacrylate, 1:1 methylmethacrylate-glycidylacrylate and a 62.5:24:13.5 methylmethacrylate-ethyl acrylate-glycidylmethacrylate.

Other useful epoxy resins are well known and contain such epoxides as epichlorohydrins, e.g. epichlorohydrin; alkylene oxides, e.g., propylene oxide, styrene oxide; alkenyl oxides, e.g., butadiene oxide; glycidyl esters, e.g., ethyl glycidate.

The polymers of the epoxy resin may optionally contain other functionalities that do not substantially interfere with cationic cure at room temperature.

Blends of various epoxy-containing materials are particularly contemplated in this invention. Examples of such blends include two or more molecular weight distributions of epoxy-containing compounds, such as low molecular weight (below 200), intermediate molecular weight (about 200 to 10,000) and higher molecular weight (above about 10,000). Alternatively or additionally, the epoxy resin may contain a blend of epoxy-containing materials having different chemical nature, such as aliphatic and aromatic, or functionality such as polar and non-polar. Other cationically polymerizable polymers may additionally be incorporated. Particularly preferred epoxy containing compositions also contain materials having hydroxyl functionality.

These polymerizable organic materials can be used in a single kind or being mixed together in two or more different kinds. Mixtures of polymerizable materials, including hybrid systems containing both free-radically polymerized components and cationically polymerized components, are also contemplated.

2. Particulate Material

The dental try-in pastes of the present invention comprise a particulate material. Preferably, the particulate material is present in the try-in dental paste in an amount of about 30% w/w to about 80% w/w. More preferably, the particulate material is present in amount of about 40% w/w to about 75% w/w. The particulate material may also be present in an amount of about 50% to about 70%. Typically, the particulate material includes one or more pigment(s) and/or one or more filler(s). Preferably, the particulate material includes one or more pigment(s) and optionally one or more filler(s). Preferably, particulate material is present in an amount to provide a try-in paste having a color that matches the color of a corresponding polymerized veneer cement. As used herein, a color that “matches” is one that has a very good match between L*, a*, and b* in the CIE color space (described in greater detail in the Examples Section), and preferably demonstrates a Delta E* of eight units and more preferably demonstrates a Delta E* of three units or less when compared to a corresponding polymerized veneer cement.

Furthermore, the particulate material, e.g., pigment(s) and/or filler(s), is present in an amount to provide a try-in paste having an opacity that matches the opacity of a corresponding polymerized veneer cement. As used herein, an opacity (i.e., Contrast Ratio or CR, described in greater detail in the Examples Section) that “matches” a polymerized veneer cement is one that has a very good CR match, and preferably demonstrates a Delta CR of about ten percentage units or less when compared to a corresponding polymerized veneer cement. More preferably, the CR match demonstrates a Delta CR of less than about six percentage units and even more preferably less than about three percentage units.

Pigments provide color to the restorative mass and can be of the common organic or inorganic types. In many cases an organic dye is deposited on the surface of an inorganic compound such as aluminum oxide, providing stability and ease of dispersion in various systems. The pigments may be colored (including black) pigments or white pigments. Preferably, to provide the desired shade match, the total amount of colored pigment used is at least about 0.001 weight percent (wt-%). Preferably, to provide the desired shade match, the total amount of colored pigment(s) used is no greater than about 0.1 wt-%. Typically, a white pigment can be used in an amount of up to about 5 wt-%. These weight percentages are based on the total weight of the try-in paste.

Suitable pigments are those typically used in dental applications, and are preferably FDA approved. Examples of suitable colored (including black) pigments include the metal oxides such as iron oxides, aluminum oxides, copper oxides, chromium oxides, cobalt oxides, and ruthenium oxides. In addition, mixed metal oxides, i.e., spinels, and metal salts can be utilized as potentially suitable pigments. The preferred white pigments are the oxides of titanium.

Fillers are solids generally present in a finely divided form. They are most often glass, but can be metal salts or oxides, polymers, or combinations of these. Any particulate matter that does not cause the polymerized dental restorative to fail due to excess dissolution in its intended application in the mouth may be suitable as filler. Quite often fillers are given surface treatments to improve their compatibility with the monomer and polymer matrix. Preferably, to provide the desired handling properties and shade match, the total amount of filler used is at least about 25 wt-%. Typically, to provide the desired handing properties and shade match, the total amount of filler used is no greater than about 80 wt-%, and preferably, no greater than about 70 wt-%. These weight percentages are based on the total weight of the try-in paste.

Suitable fillers are those typically used in dental applications and can be selected from any material suitable for use in medical applications. The fillers can be finely divided and preferably have a maximum particle diameter less than about 50 micrometers and an average particle diameter less than about 10 micrometers. The fillers can have a unimodal or polymodal (e.g., bimodal) particle size distribution. The filler can be an inorganic material. It can also be a crosslinked organic material that is insoluble in the polymerizable resin, and is optionally filled with inorganic filler. The filler should in any event be non-toxic and suitable for use in the mouth. The filler can be radiopaque, radiolucent or non-radiopaque. Preferred fillers are white or nearly white.

Suitable inorganic fillers include naturally occurring or synthetic materials such as quartz, nitrides (e.g., silicon nitride), zirconia-silica, glasses derived from, e.g., Ce, Sb, Sn, Zr, Sr, Ba, and Al. Other fillers include colloidal silica, feldspar, borosilicate glass, kaolin, talc, titania, and zinc glasses. Also suitable are the radiopaque, Zr—Si sol-gel fillers such as those described in U.S. Pat. No. 4,503,169 (Randklev) and submicron silica (e.g., pyrogenic silicas such as the AEROSIL series OX 50, 130, 150, and 200 silicas commercially available from Degussa Co., Germany and CAB-O-SIL M5 silica sold by Cabot Corp., Tuscola, Ill.). Optionally, the surface of the filler particles may be treated with a surface treatment, such as a silane coupling agent, as disclosed in U.S. Pat. No. 6,030,606 (Holmes).

Examples of suitable organic filler particles include filled or unfilled pulverized polycarbonates, polyepoxides, and the like. Preferred non-acid reactive filler particles are quartz, submicron silica, and non-vitreous microparticles of the type described in U.S. Pat. No. 4,503,169. Mixtures of these non-acid reactive fillers are also contemplated, as well as combination fillers made from organic and inorganic materials. The particulate material for use in the try-in pastes of the invention may also comprise microfillers, comprised of composite materials that have been ground to an average particle diameter of less than about 50 micrometers, more preferably an average particle diameter less than about 10 micrometers.

In certain embodiments of the invention, the surface of the filler particles may be treated with a coupling agent in order to enhance the bond between the filler and the polymerizable resin. The suitable coupling agents include gamma-methacryloxypropyltrimethoxysilane, gamma-mercaptopropyltriethoxysilane, gamma-aminopropyltrimethoxysilane, and the like.

3. Polymerization Initiation Systems

The most common initiation system for veneer cements is one made up of one or more initiators and, optionally, one or more accelerators. An initiator often is a strained compound like a diketone, for example, camphorquinone, and a tertiary amine accelerator, for instance, diethylaminoethyl-methacrylate. Many other examples exist of systems like the aforementioned that are activated by visible light in the blue range; however, luting cements with other initiation systems would function in much the same way in application of this invention. Examples of additives present in other initiation systems include benzoin, diphenyliodonium salts, organic peroxides, persulfates, and boranes. The dental curable composition of the present invention is cured by polymerizing the polymerizable monomer by using a polymerization initiator (polymerization catalyst). It is therefore desired that the dental curable composition of the present invention contains the polymerization initiator. Such initiators can be used alone or in combination with one or more accelerators and/or sensitizers. As the polymerization initiator, there can be used known polymerization initiators without any limitation. In general, the polymerization initiator of a different kind is used depending upon means for polymerizing the polymerizable monomer.

Compositions of the invention that are free-radically polymerized preferably contain one or more suitable photopolymerization initiators that act as a source of free radicals when activated. Likewise, if the polymerizable material is a cationically polymerizable material, the initiator is a cationic polymerization initiator. The photoinitiator should be capable of promoting free radical crosslinking of the ethylenically unsaturated moiety on exposure to light of a suitable wavelength and intensity. Preferably, it also is sufficiently shelf stable and free of undesirable coloration to permit its storage and use under typical dental conditions. Visible light photoinitiators are preferred. The photoinitiator frequently can be used alone, but typically it is used in combination with a suitable donor compound or a suitable accelerator (for example, amines, peroxides, phosphorus compounds, ketones and alpha-diketone compounds).

Preferred visible light-induced initiators include camphorquinone (which typically is combined with a suitable hydrogen donor such as an amine), diaryliodonium simple or metal complex salts, chromophore-substituted halomethyl-s-triazines and halomethyl oxadiazoles. Particularly preferred visible light-induced photoinitiators include combinations of an alpha-diketone, e.g., camphorquinone, and a diaryliodonium salt, e.g., diphenyliodonium chloride, bromide, iodide or hexafluorophosphate, with or without additional hydrogen donors (such as sodium benzene sulfinate, amines and amine alcohols).

Preferred ultraviolet light-induced polymerization initiators include ketones such as benzyl and benzoin, and acyloins and acyloin ethers. Preferred commercially available ultraviolet light-induced polymerization initiators include 2,2-dimethoxy-2-phenylacetophenone (“IRGACURE 651”) and benzoin methyl ether (2-methoxy-2-phenylacetophenone), both from Ciba-Geigy Corp.

The photoinitiator should be present in an amount sufficient to provide the desired rate of photopolymerization. This amount will be dependent in part on the light source, the thickness of the layer to be exposed to radiant energy, and the extinction coefficient of the photoinitiator. Typically, the photoinitiator components will be present at a total weight of about 0.01 to about 5%, more preferably from about 0.1 to about 5%, based on the total weight of the composition.

B. Method of Selecting a Veneer Cement

Another aspect of the invention provides methods for selecting a veneer cement for bonding a dental prosthesis to a tooth of a patient, which method comprises selecting a first try-in paste for trial placement of the prosthesis on the tooth; applying the dental prosthesis to the tooth of the patient using the try-in paste; comparing the shading of the dental prosthesis having the try-in paste applied thereto to the shading of the other teeth of the patient to determine if there is an appropriate match; removing the try-in paste from the tooth and prosthesis surfaces; and bonding the prosthesis to the tooth using a corresponding veneer cement; wherein the try-in paste comprises essentially the same composition as the veneer cement but has a reduced amount of polymerization initiator and/or polymerization accelerator to give the try-in paste extended working time during the trial placement of the tooth. If no appropriate match exists the try-in paste can be removed and another try-in paste of another color applied with the dental prosthesis to determine if a better match is achieved. An extended working time represents the period of time in which the try-in paste does not polymerize. Preferably, the extended working time is at least 2 minutes, more preferably at least 4 minutes and even more preferably at least 8 minutes, under typical dental office conditions. The extended working time may be between about 2 minutes and about 20 minutes, between about 4 minutes and about 15 minutes or between about 6 minutes and about 10 minutes. In case use of the first try-in paste does not provide an appropriate match, it can be removed from the tooth and prosthesis surfaces and replaced by successive try-in pastes until a match is found that provides the desired shade for the restored tooth. The method is continued by removing the try-in paste from the tooth and prosthesis surfaces and bonding the prosthesis to the tooth using a corresponding veneer cement.

The tooth surface can be prepared before placement of the try-in paste or after. Preparation includes cleaning, which is typically done using a pumice-based product, and etching or priming. The veneer is usually delivered from the fabrication laboratory prepared with a silane reacted on its etched inner (bonding) surface. The try-in paste is placed on the veneer and the veneer placed on the prepared tooth. By using a formulation very similar to the veneer cement, the dentist also can prejudge the effects of the veneer cement viscosity on required placement forces. As opposed to water-soluble try-in systems, the only steps after trial with a try-in paste of this invention are removal with a swab and placement of the uncured veneer cement. Although the try-in gels are supposed to wash off with water, many researchers have found a reduction in bond strength results if the veneer is not also washed with a solvent to remove traces of the gel and water. Ultrasonication is also recommended, as is replacement of the silane layer. The method of the invention does not require these extra time-consuming steps.

The present invention provides an improved method of selecting the shade of a luting cement, especially a veneer cement, for restoration of a tooth by using try-in pastes in trial placements of the dental prosthesis to preview the eventual result to the satisfaction of the dentist and the patient. The method allows for selection of one or more other try-in pastes when the first does not give the desired result. It allows for immediate completion of the permanent restoration placement without unnecessary cleaning steps.

The method may further comprise the step of applying a compatible adhesive to the prosthesis or tooth, after removal of the try-in paste and before final cementation with the veneer cement. The adhesive mixes with and thins the residue of the try-in paste and prepares the surface to accept the cement. A solvent-containing adhesive is quite useful for this purpose, but the invention is not limited to any specific kind of adhesive or cement, as long as they are compatible. A small amount of try-in paste when mixed in with the adhesive layer does not have an adverse effect on the adhesive strengths of the veneer cement to the veneer or tooth since it is made of similar components. The adhesive and veneer cement supply the missing initiation components that allow the residual try-in paste to fully cure.

A further aspect of the invention provides kits for selecting a veneer cement, which contain a veneer cement and non-water-removable try-in paste according to the invention. Preferably, the kit comprises one or more try-in pastes for trial placement of the prosthesis on the tooth and veneer cement(s) of corresponding shade, for permanently adhering the prosthesis to the tooth, wherein the try-in paste comprises essentially the same composition as the veneer cement but has a reduced amount of polymerization initiator and/or polymerization accelerator to give the try-in paste extended working time during the trial placement of the prosthesis. Kits are preferred that, along with the cement and paste, contain one or more application or removal aids, e.g. swabs and/or brushes. The actual material(s) is (are) housed in suitable, i.e. preferably air- and light-tight, containers. Kits are preferred that, along with the cement and paste, contain a supply of disposable tips that fit onto the light-tight containers, e.g. needles or canulas, that help to dispense the material onto the prosthesis. The kit additionally may comprise instructions. The instructions can be provided with the kit (e.g., instruction material provided in a package together with the kit) or separately (e.g., instruction material provided via a separate booklet, via a video or DVD, via remote access such as the Internet, etc.). The kit may also comprise a compatible tooth and/or ceramic primer, tooth conditioner, tooth cleanser, and/or dental adhesive.

### V. EXAMPLES

### Example 1

### Light Sensitivity

This example provides an example of a composition of the invention and demonstrates that try-in pastes comprising a reduced initiation system (i.e., an initiation system that is missing an accelerator as compared to the initiation system of the corresponding veneer cement) have an increased working time.

A resin-based veneer cement and its corresponding try-in paste having the following formulations were prepared:

| | Component Weight | Component Weight |
|---|---|---|
| Component | in Veneer Cement | in Try-In Paste |
| Barium glass, T-3000 | 60.00 | 60.00 |
| Fumed silica, US-202 | 5.00 | 5.00 |
| Bis-GMA | 18.88 | 19.07 |
| Triethyleneglycol | 15.45 | 15.61 |
| dimethacrylate | | |
| Camphorquinone | 0.05 | 0.05 |
| Benzil | 0.01 | 0.01 |
| Benzophenone | 0.18 | 0.18 |
| Diethylaminoethylacrylate | 0.35 | 0.00 |
| Titanium dioxide | 0.72 | 0.72 |
| Iron oxide, yellow | 0.006 | 0.004 |
| Iron oxide, red | 0.002 | 0.002 |

The veneer cement and try-in paste formulations were individually mixed until smooth pastes resulted. The pastes were further mixed under reduced pressure to remove air voids. To compare the color of the veneer cement and try-in paste formulations, a 0.10-gram portion of the veneer cement was sandwiched between two glass microscope slides using No. 1 glass cover slips as spacers. The thin disk, approximately 100 microns thick, was irradiated in all areas for at least 30 seconds using an Optilux 501 dental curing unit. One of the glass slides was then removed and a 0.10-gram portion of the try-in paste was placed on the slide near the cured disk. The glass slide was replaced so that both materials were formed into disks that were touching one another, but the material of the try-in paste was not irradiated. The two disks were visually compared for color match on an standard off-white background (Minolta) using a dental operatory light, an incandescent light, a D65 light (Minimatcher), indirect sunlight, or fluorescent light. Under all lights the two disks are not more than barely perceptibly different in color. Using the operatory light, the color match was evaluated on a black background (Ceram Research) and on a block of A3 shade Accolade Flowable Composite (Danville Materials). A small mismatch was noted on the black background, but the color difference on the tooth-shaded background was imperceptible.

To evaluate the sensitivity of the veneer cement and try-in paste to ambient light, a dental operatory light was positioned above a light meter to obtain a reading of about 10,000 lux. About 30 mg of the veneer cement was placed in the center of a 1″×3″ glass microscope slide that was then laid on the meter to receive the 10,000-lux light for 60 seconds. Immediately after that, a second microscope slide, perpendicular to the first slide, was pressed onto the mass to create a thin layer in the form of a disk that would reach nearly to the edges of the intersection of the glass slides. The disk edges appeared smooth and the bulk appeared homogeneous, indicating that the operatory light did not affect the composite.

A second test was performed to evaluate the sensitivity of the veneer cement to ambient light at 10,000 lux except that this time the exposure was allowed for 120 seconds. The resulting disk had areas of clefts and voids in addition to white spots indicating that the composite had started to polymerize by the action of the operatory light. The same test was performed on a sample of the try-in paste. After 120 seconds exposure at 10,000 lux the resulting disk was uniform and homogeneous, indicating that no polymerization could be detected. In sensitivity to ambient light trials on the try-in paste at 240 and 480 seconds, the try-in paste showed no signs of polymerization under exposure at 10,000 lux. The try-in paste was further tested for sensitivity at 240 seconds to more intense light exposures. No effect was seen at about 15,000 or 20,000 lux. However, when exposed to the operatory light at about 30,000 lux for 240 seconds, the try-in paste presented indications that the light was able to effect some polymerization.

The opacity of a light-cured 1 mm disk of the cured veneer cement was determined by measuring the color in the Yxy color space (CIE 1931) against a standard white background and a standard black background. Opacity is expressed as the ratio of the grayscale value (Y) on black to the value on white given as a percentage. The value obtained was 65.0%. In a similar manner the opacity of uncured try-in paste was 69.9%. Both test disks include glass cover slips. The refractive index of cured veneer cement was determined by preparing a 4 mm thick block, polishing two sides to form a square edge. The block was placed on a refractometer (Abbe 3L by Baush and Lomb) with a small portion of 1-bromonaphthalene (Thermo Spectronic) on the prism. The result was 1.5417 measured at 23° C. The refractive index of the try-in paste was determined by placing a small portion directly between the refractometer prisms. The result was 1.5388.

### Example 2

### Bond Strength of Veneer Cement/Try-in Paste

This example provides a composition of the invention. Additionally, this example demonstrates that application and removal of a try-in paste according to the invention does not diminish the bond strength of the veneer cement.

A resin-based veneer cement and its corresponding try-in paste having the following formulations were prepared:

| | Component Weight | Component Weight |
|---|---|---|
| Component | in Veneer Cement | in Try-In Paste |
| Barium glass, SP-345 | 64.00 | 64.00 |
| Fumed silica, RS-972 | 3.00 | 3.00 |
| Bis-GMA | 4.81 | 4.81 |
| Triethyleneglycol | 4.81 | 4.81 |
| dimethacrylate | | |
| Ethoxylated Bis-GMA | 22.47 | 22.47 |
| Camphorquinone | 0.066 | 0.05 |
| Benzophenone | 0.33 | 0.33 |
| Ethyldimethylaminobenzoate | 0.435 | 0.0 |
| Titanium dioxide | 0.06 | 0.06 |
| Iron oxide, yellow | 0.003 | 0.003 |
| Iron oxide, red | 0.001 | 0.001 |

The veneer cement and try-in paste formulations were individually mixed until smooth pastes resulted. The pastes were further mixed under reduced pressure to remove air voids. Shear bond strength testing was performed according to ISO/TS 11405:2003(E), Annex A.3.2. In the first set of tests, five extracted human teeth were ground flat without exposing dentin. On each tooth, this ground enamel surface was covered with Mylar tape having a 3 mm hole. The unmasked area was treated for 15 seconds with 37% phosphoric acid solution, then rinsed well and dried with oil-free air. Prelude Adhesive (Danville Materials) was scrubbed into the surface for 10 seconds and then the adhesive layer was thinned by application of air from a dental air/water syringe. A 1-2 mm layer of veneer cement was applied to the surface and cured 30 seconds using an Optilux 501 dental curing light (Demetron). Likewise a second layer of the veneer cement was applied and cured. The entire assembly was stored in water at 37° C. for 24 hours. After storage the composite was sheared from the tooth surface at a rate of 1 mm/minute while the force required was recorded. The maximum force required to dislodge the composite divided by the bonded area obtains the shear bond strength. The average of five determinations was 26.7 MPa.

In the second set of tests, teeth were ground, masked, and treated as before. Try-in paste was applied to the tooth surface and allowed to stand for 5 minutes. Then a brush with straight bristles was used to remove the majority of the try-in paste. Prelude Adhesive was applied as in the first set of tests and then veneer cement was applied and cured in two layers as before. After 24 hours storage in water at 37° C. the shear bond strength was determined for the five specimens. The average strength was 27.6 MPa.

In a similar way, the bond strength of the veneer cement to porcelain was determined with and without application and removal of the try-in paste from the surface. The Empress porcelain (Ivoclar) was sanded to flatness, air abraded with a stream of 50-micron aluminum oxide (Danville Engineering) from a PrepStart (Danville Engineering) running at 80 psi. The surface was treated with 9.6% HF gel (Pulpdent), rinsed, and dried. The surface was then treated with Bond Star S (Danville Materials) and dried. For the third set of bond tests Prelude Adhesive was applied and dried followed by twice applying and curing layers of veneer cement. After 24 hours storage, the average shear bond strength of five specimens was 20.8 MPa. For the fourth set of bond tests, the try-in paste was applied to the surface of the Bond Star S-treated porcelain and allowed to stand 5 minutes. It was mostly removed with a bristle brush and the Prelude Adhesive and two layers of veneer cement were applied as in the third test. In this case where the try-in paste was applied and then removed, the average shear bond strength of five specimens was 23.9 MPa. The following table summarizes the bond strength results:

| | Without Try-In Paste | With Try-In Paste |
|---|---|---|
| Bond Strength to Etched | 26.7 | 27.6 |
| Enamel, MPa | | |
| Bond Strength to Silane | 20.8 | 23.9 |
| Treated Empress, MPa | | |

### Example 3

### Bond Strength after Removing Water-Soluble Try-in Gel

This example demonstrates that the prior art, water-soluble, try-in gels provide a lesser bond between the tooth and dental prosthesis.

A resin-based veneer cement and its matching water-soluble try-in gel having the following formulations were prepared:

| | Component Weight | Component Weight |
|---|---|---|
| Component | in Veneer Cement | in Try-In Gel |
| Barium glass, SP-345 | 40.00 | 0.0 |
| Barium glass, SP-92 1 | 20.00 | 5.00 |
| Fumed silica, OX-50 | 3.00 | 20.00 |
| Triethyleneglycol | 7.35 | 0.0 |
| dimethacrylate | | |
| Ethoxylated Bis-GMA | 29.40 | 0.0 |
| Camphorquinone | 0.067 | 0.0 |
| Ethyldimethylaminobenzoate | 0.067 | 0.8 |
| Titanium dioxide | 0.1 | 0.12 |
| Iron oxide, yellow | 0.008 | 0.01 |
| Iron oxide, red | 0.002 | 0.002 |
| Water | 0.0 | 8.42 |
| Glycerin | 0.0 | 65.65 |
| Gelatin | 0.0 | 0.94 |
| Sorbic acid | 0.0 | 0.0085 |

The veneer cement formulation components were mixed until a smooth paste resulted. The paste was further mixed under reduced pressure to remove air voids. To prepare the try-in gel, water, sorbic acid and 28.5% of the glycerin were heated to 50° C. with strong stirring. The gelatin was added slowly to prevent clumping. Separately, the remaining glycerin was also heated to 50° C. and was added after the gelatin was completely wetted. Finally, the iron oxides, titanium dioxide, fumed silica and barium glass filler were added with mixing until a smooth paste was obtained which was allowed to cool with slow mixing.

The color of 100-micron disks of the veneer cement and try-in gel were compared as described in Example 1. In this case, however, the paste and gel were sandwiched side-by-side at the same time and the veneer cement light cured. The curing light had no effect on the try-in gel. On a white background under a D65 light, the disks are perceptibly different in color. Also, under the operatory light the disk colors are perceptibly different, with the try-in gel being more yellow and less gray than the veneer cement. A good match is obtained under incandescent light. Under fluorescent light, the try-in gel appears nearly clear while the veneer cement is dark and opaque. Under an operatory light, the disks were compared on a black background and on a block of A3 shade Accolade. Much more of the black background shows through the try-in gel than through the cured veneer cement disk. On the A3 background, the resulting color of the veneer cement disk is lighter than the try-in gel disk.

The opacity of the cured veneer cement and try-in gel were determined as described in Example 1. The 1 mm disk of veneer cement measured 54.5% opacity. The disk of try-in gel measured 58.9%. The refractive indices of the cured veneer cement and try-in gel were determined as described in Example 1. The block of cured veneer cement measured 1.5119. The try-in gel measured 1.4283.

The shear bond strength of the veneer cement to enamel and porcelain was determined as described in Example 2. The results are shown in Table below. The bond strengths of the veneer cement to enamel and porcelain were also determined after the try-in gel had been allowed to stand on the surface for 5 minutes and then removed. The gel was removed with a strong stream of water followed by drying with an air stream. The following table summarizes the bond strength results:

| | Without Try-In | With Try-In |
|---|---|---|
| Bond Strength to Etched | 24.9 | 23.7 |
| Enamel, MPa | | |
| Bond Strength to Silane | 19.8 | 13.6 |
| Treated Empress, MPa | | |

### Example 4

### Color and Opacity of Try-in Pastes and Veneer Cements

This example demonstrates that the try-in pastes of the invention provide an acceptable color match to the corresponding veneer cements. Color and opacity measurements of trial paste samples were made by the following procedure. Samples of the try-in paste or cement were prepared by sandwiching 0.22 g paste between two No. 1 glass cover slips within a 1×20 mm steel ring, placing the assembly directly in contact with the background, and then measuring using a Minolta CR-300 with D-65 source. Each sample was tested against four background colors: white, black, a block of Accolade matching the A1 shade of a Vitapan classical Shade Guide (Vita Zahnfabrik, Bad Sackingen, Germany) and a block of Accolade matching the A3 shade of the Vitapan Shade Guide. For the Accolade samples, the commercial available veneer cement was compared to a try-in paste that is the base Accolade cement minus the accelerator. For the Cosmedent da vinci system, the commercially available cement and corresponding commercially available try-in gel were compared. The cement color was determined in the same way except that it is first irradiated for 30 seconds on each side from an Optilux dental curing unit (Kerr Mfg.).

The comparison of color matching between trial paste and cured cement samples was obtained by calculating Delta E*, a calculation for determining the distance between two points in the L*, a*, b* color coordinate space. Delta E*=Square Root ((L*_{T}−L*_{C})²+(a*_{T}−a*_{c})²+(b*_{T}−b*_{C})²), where L*_{T}, a*_{T}, and b*_{T} are the L*, a*, and b* color coordinates of the trial paste samples and L*_{C}, a*_{C}, and b*_{C} are the L*, a*, and b* color coordinates of the cured cement samples. In general, a color difference (Delta E*) of less than three units is considered to be an excellent match and difficult to discern a color difference by visual observation. The color match of the try-in pastes and corresponding veneer cements of the present invention compares well to the commercial system, da vinci (Cosmedent) on some surfaces. While the commercial system demonstrates a better measured color match under some of the experimental conditions, visual comparison under different lighting show the compositions of the present invention to be better (data not shown). Opacity was measured as described in Example 1. An opacity difference less than about 5.0 is considered to be an excellent match and difficult to discern an opacity difference by visual observation. The opacity match of the try-in pastes and corresponding veneer cements is better than the commercial system for most shades. While not being limited to a theory of the invention, it is believed that the decreased opacity difference for the try-in pastes of the invention may be responsible for the improved visual match under different lighting conditions.

| | E Value Between Cured | | | | |
|---|---|---|---|---|---|
| | Cement and Uncured Try-In | | | | Opacity Abs |
| Shade | White | Black | A1 | A3 | Difference, % |
| Accolade PV Translucent | 5.92 | 13.64 | 9.71 | 10.78 | 9.00 |
| Accolade PV Light | 6.78 | 5.32 | 5.86 | 5.60 | 3.37 |
| Accolade PV Extra Light | 6.73 | 5.59 | 5.68 | 5.56 | 0.85 |
| Accolade PV | 4.20 | 3.99 | 4.06 | 4.11 | 0.42 |
| White Opaque | | | | | |
| Accolade PV Yellow | 5.27 | 5.97 | 5.60 | 4.70 | 5.35 |
| Accolade PV Brown | 5.49 | 6.32 | 5.97 | 6.10 | 2.97 |
| Cosmedent da | 7.94 | 4.68 | 1.99 | 1.11 | 5.63 |
| vinci Clear | | | | | |
| Cosmedent da | 5.05 | 3.76 | 3.28 | 3.50 | 8.87 |
| vinci Bright | | | | | |

These results demonstrate that a try-in paste of the invention can be made that matches the color of the corresponding cured veneer cement under some combinations of background shade and light source. Bond strength studies show that application and subsequent removal of the try-in pastes of the invention do not harm the adhesive strength to dentin when a trial placement is made. By comparison, aqueous try-in gels may cause some reduction of bond strength to porcelain.

Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A try-in dental paste that comprises a dentally-acceptable particulate material, a dentally-acceptable organic material that polymerizes to aid in bonding a tooth prosthesis to a patient's tooth, a polymerization initiator for the organic material and optionally a polymerization accelerator, wherein the try-in paste is not water-removable and wherein the initiator and the optional accelerator are available in an amount to give the try-in paste extended working time during a trial placement of the tooth prosthesis to the patient's tooth so that the shading of the prosthesis is appropriately matched to the patient's other teeth.

2. The try-in paste of claim 1, wherein the particulate material is present in an amount of about 30% w/w to about 80% w/w and the organic material is present in an amount of about 20% w/w to about 70% w/w.

3. The try-in paste of claim 1, wherein the polymerization accelerator is absent.

4. The try-in paste of claim 1, wherein the organic material is a methyacrylate compound.

5. The try-in paste of claim 4, where the methacrylate compound is Bowen monomer bis-GMA, triethylene glycol dimethacrylate, ethoxylated Bis-GMA, triethyleneglycol dimethacrylate or mixtures thereof.

6. The try-in paste of claim 1, wherein the particulate material is a combination of a filler and a pigment.

7. The try-in paste of claim 1, wherein the particulate material has a maximum particle diameter of less than 50 micrometers.

8. A method for selecting a veneer cement for bonding a dental prosthesis to a tooth of a patient, which method comprises:
i) selecting a first try-in paste for trial placement of the prosthesis on the tooth;
ii) applying the dental prosthesis to the tooth of the patient using the try-in paste;
iii) comparing the shading of the dental prosthesis having the try-in paste applied thereto to the shading of the other teeth of the patient to determine if there is an appropriate match;
iv) removing the try-in paste from the tooth and prosthesis surfaces; and
v) bonding the prosthesis to the tooth using a corresponding veneer cement;
wherein the try-in paste comprises essentially the same composition as the veneer cement but has a reduced amount of polymerization initiator and/or polymerization accelerator to give the try-in paste extended working time during the trial placement of the tooth.

9. The method of claim 8, wherein if no appropriate match is found, the method further comprises:
a) removing the try-in paste from the tooth and prosthesis surfaces; and
b) repeating steps i)-iii) with a second try-in paste.

10. The method of claim 8, wherein the try-in paste comprises a dentally-acceptable particulate material, a dentally-acceptable organic material that polymerizes to aid in bonding a tooth prosthesis to a patient's tooth, a polymerization initiator for the organic material and optionally a polymerization accelerator.

11. The method of claim 10, wherein the particulate material is present in an amount of about 30% w/w to about 80% w/w and the organic material is present in an amount of about 20% w/w to about 70% w/w.

12. The method of claim 10, wherein the polymerization accelerator is absent.

13. The method of claim 10, wherein the organic material is a methyacrylate compound.

14. The method of claim 13, where the methacrylate compound is Bowen monomer bis-GMA, triethylene glycol dimethacrylate, ethoxylated Bis-GMA, triethyleneglycol dimethacrylate or mixtures thereof.

15. The method of claim 10, wherein the particulate material is a combination of a filler and a pigment.

16. The method of claim 10, wherein the particulate material has a maximum particle diameter of less than 50 micrometers.

17. A kit for selecting a veneer cement for bonding a dental prosthesis to a tooth of a patient, which kit comprises a try-in paste for trial placement of the prosthesis on the tooth and a veneer paste, for permanently adhering the prosthesis to the tooth, wherein the try-in paste comprises essentially the same composition as the veneer cement but has a reduced amount of polymerization initiator and/or polymerization accelerator to give the try-in paste extended working time during the trial placement of the prosthesis.

18. The kit of claim 17, wherein the try-in paste comprises a dentally-acceptable particulate material, a dentally-acceptable organic material that polymerizes to aid in bonding a tooth prosthesis to a patient's tooth, a polymerization initiator for the organic material and optionally a polymerization accelerator.

19. The kit of claim 18, wherein the particulate material is present in an amount of about 30% w/w to about 80% w/w and the organic material is present in an amount of about 20% w/w to about 70% w/w.

20. The kit of claim 18, wherein the polymerization accelerator is absent.

21. The kit of claim 18, wherein the organic material is a methyacrylate compound.

22. The kit of claim 21, where the methacrylate compound is a Bowen monomer bis-GMA, triethylene glycol dimethacrylate, ethoxylated Bis-GMA, triethyleneglycol dimethacrylate or mixtures thereof.

23. The kit of claim 18, wherein the particulate material is a combination of a filler and a pigment.

24. The kit of claim 18, wherein the particulate material has a maximum particle diameter of less than 50 micrometers.
